(19) United States
(12) Patent Application Publication
(10) Pub. No.: US 2009/0192638 A1
(43) Pub. Date: Jul. 30, 2009

(54) DEVICE FOR AND METHOD OF GENERATING AUDIO DATA FOR TRANSMISSION TO A PLURALITY OF AUDIO REPRODUCTION UNITS

(75) Inventors: Adriaan Johan Van Leest, Eindhoven (NL); Daniel Willem Elisabeth Schobben, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/303,416

(22) PCT Filed: May 10, 2007
(86) PCT No.: PCT/IB07/51769

§ 371 Date: Dec. 4, 2008

(30) Foreign Application Priority Data
Jun. 9, 2006 (EP) 06115232.8

(51) Int. Cl. G06F 17/00

(52) U.S. Cl. 700/94

(57) ABSTRACT

A device (100) for generating audio data for transmission to a plurality of audio reproduction units (110), the device (100) comprising an audio content transmission unit (101) adapted to transmit audio content for reproduction to the plurality of audio reproduction units (110), and a local audio data transmission unit (102) adapted to transmit local audio data individually to each of the plurality of audio reproduction units (110), the local audio data being indicative of a manner of processing transmitted audio content locally at the respective audio reproduction unit (110) to generate locally reproducible audio content.

### FIELD OF THE INVENTION

The invention relates to a device for generating audio data for transmission to a plurality of audio reproduction units.

Moreover, the invention relates to an audio reproduction unit.

The invention further relates to a method of generating audio data for transmission to a plurality of audio reproduction units.

Beyond this, the invention relates to a program element.

Further, the invention relates to a computer-readable medium.

### BACKGROUND OF THE INVENTION

Audio playback devices become more and more important. Particularly, an increasing number of users buy harddisk-based audio players and other entertainment equipment. Also audio surround systems become more and more important.

US 2005/0152557 A1 discloses that sound produced by a speaker device of a plurality of speaker devices is captured by a microphone in each of the plurality of speaker devices. A server apparatus receives an audio signal of the captured sound from all speaker devices, and calculates a distance difference between the distance of a location or position of a listener, who is located within an area defined by the plurality of speaker devices, to the speaker device closest to the listener and the distance of the listener to each of the plurality of speaker devices. When one of the speaker devices emits a sound sample, the server apparatus receives an audio signal of the sound captured by and transmitted from each of the other speaker devices. The server apparatus calculates a speaker-to-speaker distance between the speaker device that has emitted the sound and each of the other speaker devices. The server apparatus calculates a layout configuration of the plurality of speaker devices based on the distance difference and the speaker-to-speaker distance.

US 2005/0015805 A1 discloses a system for controlling video and audio devices distributed over a power-line communication (PLC) network. Streaming video and/or audio is communicated between media devices interfaced with a power-line communication network. The devices are typically controlled by a media server which is preferably configured for receiving commands from a user utilizing a remote control unit, wherein commands are received by a media device, and certain commands which are not directed at that media device are passed through the media device to the media server for controlling the action of other media devices. The server supports adjusting encoding and/or decoding latency for synchronizing streams being input or output on media devices. Locking functions and password control features are provided for limiting control or dissemination of content. Rate control is preferably provided for limiting bandwidth utilization by streams, and a room-to-room live pause feature to prevent loss due to interruptions.

However, there are circumstances under which the functionality of such systems is not sufficient.

### OBJECT AND SUMMARY OF THE INVENTION

It is an object of the invention to enable efficient audio data processing.

In order to achieve the object defined above, a device for generating audio data for transmission to a plurality of audio reproduction units, an audio reproduction unit, a method of generating audio data for transmission to a plurality of audio reproduction units, a program element and a computer-readable medium according to the independent claims are provided.

According to an exemplary embodiment of the invention, a device for generating audio data for transmission to a plurality of audio reproduction units is provided, the device comprising a first audio data transmission unit (which may also be denoted as an audio content transmission unit) adapted to transmit audio content for reproduction to the plurality of audio reproduction units, and a second audio data transmission unit (which may also be denoted as a local audio data transmission unit) adapted to transmit local audio data individually to each of the plurality of audio reproduction units, the local audio data being indicative of a manner of processing the transmitted audio content locally at the respective audio reproduction unit to generate (that is to say yielding) locally reproducible audio content.

According to another exemplary embodiment of the invention, an audio reproduction unit for reproducing audio data generated by a device for generating audio data for transmission to a plurality of audio reproduction units having the above-mentioned features is provided, the audio reproduction unit comprising a first audio data receipt unit (which may also be denoted as an audio content receipt unit) adapted to receive the audio content for reproduction, and a second audio data receipt unit (which may also be denoted as a local audio data receipt unit) adapted to receive the local audio data being indicative of a manner of processing the received audio content locally to generate locally reproducible audio content.

According to another exemplary embodiment of the invention, a method of generating audio data for transmission to a plurality of audio reproduction units is provided, the method comprising transmitting audio content for reproduction to the plurality of audio reproduction units, and transmitting local audio data individually to each of the plurality of audio reproduction units, the local audio data being indicative of a manner of processing the transmitted audio content locally at the respective audio reproduction unit to generate (that is to say yielding) locally reproducible audio content.

According to still another exemplary embodiment of the invention, a program element is provided, which, when being executed by a processor, is adapted to control or carry out a method of generating audio data for transmission to a plurality of audio reproduction units having the above mentioned features.

According to yet another exemplary embodiment of the invention, a computer-readable medium is provided, in which a computer program is stored which, when being executed by a processor, is adapted to control or carry out a method of generating audio data for transmission to a plurality of audio reproduction units having the above mentioned features.

The audio processing according to embodiments of the invention can be realized by a computer program, which is by software, or by using one or more special electronic optimization circuits, that is in hardware, or in hybrid form, that is by means of software components and hardware components.

According to an exemplary embodiment of the invention, an audio system having a control entity and a plurality of locally distributed loudspeakers may be provided. To keep the required bandwidth small and to provide a flexible system that allows a dynamic adding or removal of loudspeakers even during use of the device, a stream of audio content may be distributed regardless to the number of and the arrangement of the receiving loudspeakers. Additionally, only a small amount of additional control data is sent individually to a part of or to each of the recognized loudspeakers that may serve to selectively modify the audio content in accordance with the specific function and/or location of the respective loudspeaker in the network. For instance, gain and/or delay information may be contained in such local audio data.

Such a system may solve the issue that the bandwidth required may increase with the number of loudspeakers installed. According to an exemplary embodiment of the invention, a substantially low bit rate stream essentially independent of the number of loudspeakers employed is sent, and sound is rendered locally at the loudspeaker terminals using spatial rendering parameters. Such a system may be implemented within an automatic loudspeaker position finding array and may use a network based on power line communication. Such a system may significantly distinguish from a system in which packets of audio data are just sent out for every loudspeaker in a time sequential manner, which may be less efficient with regard to bandwidth requirements.

According to an exemplary embodiment of the invention, a dynamic scaleable audio surround system with loudspeakers everywhere may be provided. In this context, a method for automatically detecting/adjusting the layout configuration of a multi-speaker audio system may be provided in which a power line communication is used for communication. An arbitrary number of speakers can be connected without essentially altering bandwidth requirements.

Audio surround systems may have up to seven connected loudspeakers, or more. In practice, consumers conventionally have problems to set up these loudspeakers correctly (for example due to the physical layout in the room) and the audio-video sensation may decrease significantly.

According to an exemplary embodiment of the invention, a reproduction (loudspeaker) unit may be provided, comprising rendering means for rendering audio signals dependent on position information. Furthermore, a registration means may be provided being adapted to register the reproduction unit to a sound system that comprises a number of (one or more) further reproduction units. Measuring means may be adapted to measure distances between the reproduction unit and the further reproduction unit(s) yielding distance information. A calculation unit may be provided for calculating gain and/or delay information for each loudspeaker based on the distance information. Interface means may be provided for transmitting said gain and delay information to the loudspeakers.

If a loudspeaker is removed, which may be detected by the system since the loudspeaker does not respond any more, new gains and delays may be computed and sent to the further reproduction units. Thus, loudspeakers may be added or removed dynamically. In this context, a dynamic surround system may be provided with an arbitrary number of loudspeakers.

According to an exemplary embodiment, the reproduction unit of the system may be adapted to receive streamed audio signals. Thus, if an additional reproduction unit is registered to the sound system, the reproduction unit needs only to know how much to delay these audio channels and with which gains these audio channels have to be multiplied. As a result, no extra bandwidth is needed for an extra audio stream to this additional reproduction unit.

To reduce even more bandwidth, a technique called spatial audio coding (SAC) may be used, so that only one or two or more (compressed) audio channels have to be streamed with some additional parameters to locally restore all audio channels.

Exemplary embodiments of the invention may be implemented in a home entertainment system.

According to an exemplary embodiment, an audio surround system is provided which may be operated with an arbitrary number of connected loudspeakers. These loudspeakers may be units that can simply be plugged into a power point in a dynamic way, that is to say during operation loudspeakers can be added or removed from a power point and the audio surround system may react accordingly in terms of sound reproduction. The communication from the surround system to the loudspeakers can, for example, be achieved via a power line communication. An advantage of such a system is that additional connected loudspeakers do not result in a significant increase of bandwidth and may therefore be highly scalable.

Audio surround systems may have up to seven connected loudspeakers. However, exemplary embodiments of the invention are not limited to seven loudspeakers, but can be used for an arbitrary number of loudspeakers. The ITU recommendations recommend how these loudspeakers should be set up (see Recommendation ITU-R BS.775-1, “multiple stereophonic sound system with and without accompanying picture”). However, in practice, consumers may have problems to set up these loudspeakers correctly, for example due to the physical layout of the room, and the audio video sensation may decrease significantly. A system according to an exemplary embodiment of the invention may automatically compensate for wrongly set up loudspeakers.

For a proper functioning of a system according to an exemplary embodiment of the invention, different frame conditions may be taken into account:

find positions of all loudspeakers in the room

process audio such that the listener has the illusion that the audio is coming from the correct direction, as recommended by ITU and/or as intended by the system

ensure that when an additional loudspeaker unit is plugged in or out, the system may react accordingly

for a highly scaleable system, the network communication should not increase too much when an additional loudspeaker unit is added.

According to an exemplary embodiment, an automatic loudspeaker configuration system is provided wherein the loudspeaker modules contain hardware for locally rendering the audio based on their positions.

For instance, using noise injection and multidimensional scaling can find the positions of the loudspeakers. The noise injection may make it possible to measure the impulse responses between loudspeakers, from which the distances can be derived. Given these distances, the positions of the loudspeakers can be computed using multidimensional scaling. As a reference for the system, the television can be used and phantom sound sources (see below) can be positioned with respect to this reference.

Amplitude panning can be used to create phantom sound sources at certain positions that the listener has the illusion that the loudspeakers are correctly placed. A phantom sound source is created by feeding each loudspeaker with the same mono audio signal, for instance with one audio channel from the sound source (for instance a DVD), but each with a different gain. For example, if two loudspeakers are connected, feeding the two loudspeakers with the same audio signal and with the same gain can create a phantom sound source in the middle of these loudspeakers. Increasing one gain, while decreasing the other, may move the position of this phantom sound source. Adding to each loudspeaker an additional audio signal, probably with different gains, may create an additional phantom sound source. In this context, explicit reference is made to van Leest, A. J, “On amplitude panning and asymmetric loudspeaker set-ups”, in: 119^{th} AES Convention, Paper 6613, pages 1 to 8, October 2005. The paper, the disclosure of which may also be implemented in an advantageous manner in the context of embodiments of the invention, describes how a computation may be performed for the gains with which the original audio channel has to be multiplied for an arbitrary number of loudspeakers and for an arbitrary loudspeaker setup. In the computation, it is assumed that the loudspeakers are equally distant from the central listener. In practice, this may not be the case. However, such a computation may be applied to a non-circular loudspeaker set-up by applying delay and gain compensation. Such a technique is described, for instance, in Gerzon, M. A., “The design of distance panpots”, In: Preprint 3308 of the 92^{nd} AES Convention, Vienna, pages 1 to 33, 1992. Explicit reference is made to the corresponding part of this paper, which may be combined in an advantageous manner with systems according to exemplary embodiments of the invention.

When a new loudspeaker unit is added, then this loudspeaker unit may make itself known to the system. The distances between this new loudspeaker unit and the other loudspeaker units may be measured and new gains and delays for all loudspeaker units may be computed and sent to the loudspeakers. If a loudspeaker unit is removed, which may be detected by the system since the loudspeaker does not respond any more, new gains and delays may be computed and sent to the remaining loudspeaker units.

Since amplitude panning may be used to create phantom sound sources, it may be sufficient to use the audio channels of the audio source (for instance the five audio channels of a DVD). These audio channels may have to be streamed to each loudspeaker. Thus, if an additional loudspeaker is plugged in, this loudspeaker unit needs only to know how much to delay these audio channels and with which gain these audio channels are to be multiplied. As a result, essentially no extra bandwidth is needed for an extra audio stream to this additional loudspeaker.

To reduce bandwidth even more, it is possible to use a technique called spatial audio coding (SAC), so that only one or two (for instance compressed) audio channels have to be streamed with some additional parameters to locally restore all audio channels. The technique of spatial audio coding (SAC) is disclosed, for instance, in Herre, J., Purnhagen, H., Breebaart, J., Faller, C., Disch, S., Kjörling, K., Schuijers, E., Hilpert, J., Myburg, F., “The reference model architecture for MPEG spatial audio coding”, In: 118^{th} AES Convention, Paper 6447, pages 1 to 13, May 2005, and in: Breebart, J., Disch, S., Faller, C., Herre, J., Hotho, G., Kjörling, K., Myburg, F., Neusinger, M., Oomen, W., Purnhagen, H., Rödén, J. “MPEG spatial audio coding/MPEG surround: Overview and current status”, In: 119^{th} AES Convention, Paper 6599, pages 1 to 17, October 2005. Such spatial audio coding schemes as disclosed in these two documents may be implemented according to exemplary embodiments of the invention.

According to a further exemplary embodiment of the invention, an automatic loudspeaker configuration system may be provided in which the loudspeaker modules contain hardware for locally rendering the audio based on their positions. Data may be transmitted from a server to a loudspeaker module using power line communication. Alternatively, data may be transmitted from a server to a loudspeaker module using a wireless communication scheme. A number of audio channels or objects may be sent to the loudspeaker modules, which number may be independent of the number of loudspeaker modules. Metadata may be sent along with an audio allowing for a very low bit rate (as in SAC). The metadata may be manipulated in the loudspeaker module based on the rendering information that depends on the loudspeaker positions. The positions of the loudspeakers may be computed at the server and rendering data may be sent from the server to the loudspeaker modules. However, the positions may be computed locally at the loudspeaker modules, this may represent an ad hoc network.

Next, further exemplary embodiments of the invention will be explained. In the following, further exemplary embodiments of the device for generating audio data for transmission to a plurality of audio reproduction units will be explained. However, these embodiments also apply to the audio reproduction unit, to the method of generating audio data for transmission to a plurality of audio reproduction units, to the program element and to the computer-readable medium.

The audio content transmission unit of the device may be adapted to transmit shared (that is the same) audio content for reproduction to each of the plurality of audio reproduction units. Therefore, it is not necessary to send individual streams of audio content specifically tailored to each individual one of the loudspeakers, which may reduce the bandwidth requirements. In other words, one and the same audio content may be sent in an unspecific manner to each of the loudspeakers. This may allow for a small bandwidth transmission of the actual audio content, for instance a song to be played back by the loudspeakers.

The audio content transmission unit may be adapted to transmit audio content for reproduction to the plurality of audio reproduction units, said audio content being independent of a number of the plurality of audio reproduction units. Since the audio content may be simply spread around all connected loudspeakers, the bandwidth is essentially independent of the number of loudspeakers attached. This may allow for a creation of a dynamic system in which loudspeakers may be simply added or removed, even during operation of the system.

The local audio data transmission unit may be adapted to transmit different local audio data to different audio reproduction units of the plurality of audio reproduction units. Thus, only the local audio data including parameter information for controlling the playback functionality of each individual loudspeaker respectively audio reproduction units may be tailored or specifically adapted to the loudspeaker. Thus, only a very small amount of data has to be individualized with regard to an individual loudspeaker. The amount of data included in local audio data may be significantly smaller than the amount of data included in audio content.

The local audio data transmission unit may be adapted to transmit local audio data individually to each of the plurality of audio reproduction units so as to render reproducible audio content locally at each of the plurality of audio reproduction units using one or more spatial rendering parameters. Thus, the spatial adaptation of the audio to be played back with respect to an individual loudspeaker may be performed based on a position of this loudspeaker in an environment (for instance in a room), particularly with respect to positions of other loudspeakers.

The local audio data transmission unit may be adapted to transmit local audio data individually to each of the plurality of audio reproduction units so as to render reproducible audio content locally at each of the plurality of audio reproduction units using one or more gain parameters and/or one or more delay parameters. Therefore, by simply adjusting the amplitude and/or the timing of the audio playback of the different loudspeakers, the generation of phantom sources using a plurality of such loudspeakers may be made possible.

The local audio data transmission unit may be adapted to transmit local audio data individually to each of the plurality of audio reproduction units, said local audio data being dependent on a number of the plurality of audio reproduction units. Therefore, when the number of connected loudspeakers is modified, only the local audio data of such additional or removed loudspeakers has to be adapted. This is possible with very low computational burden, and has essentially no consequences for the entire bandwidth requirements.

The local audio data transmission unit may be adapted to transmit local audio data individually to each of the plurality of audio reproduction units, said local audio data being dependent on a spatial distribution of the plurality of audio reproduction units. Therefore, when the system has information with regard to the spatial distribution of the different loudspeakers in space, for instance in a room, it is possible to adjust the playback parameters of the individual parameters accordingly, so as to achieve a proper audio playback quality.

The communication interface may be provided for connecting the plurality of audio reproduction units. Therefore, the device may be connected via such a communication interface to the loudspeakers. The connection may be wired (for instance via conventional cables or via a power line), or may be provided wirelessly, for instance via Bluetooth, infrared communication, etc.

The communication interface may be adapted for connecting the plurality of reproduction units in a dynamic manner. In this context, the term “dynamic” may denote a situation in which a connection of individual loudspeakers to the network or a removal of individual loudspeakers from the network is possible during operation, which allows for a very flexible system which may be operated in a user-friendly manner.

A position detection unit may be provided for detecting a position of at least a part of the plurality of audio reproduction units. Such position detection unit may communicate with the different loudspeakers and may thereby exchange signals (for instance acoustic or electromagnetic signals) on the basis of which signals the individual distances may be calculated.

The position detection unit may be coupled to the local audio data transmission unit in such a manner that the local audio data is adjustable based on the detected position of at least a part of the plurality of audio reproduction units. In other words, when the spatial relationship of the different loudspeakers has been determined, it is possible to adjust the audio playback accordingly.

The device may comprise an audio encoder unit for encoding the audio content and/or the local audio data to be transmitted to the plurality of audio reproduction units. Such an encoder unit may be based on the above-described spatial audio coding (SAC) scheme.

The device may be realized as at least one of the group consisting of an audio surround system, a gaming device, a DVD player, a CD player, a harddisk-based media player, an internet radio device, a public entertainment device, an MP3 player, a hi-fi system, a vehicle entertainment system, a car entertainment system, a medical communication system, a music theatre hall system and a home cinema system.

In the following, further exemplary embodiments of the audio reproduction unit will be explained. However, these embodiments also apply for the device for generating audio data for transmission to a plurality of audio reproduction units, for the method, for the program element and for the computer-readable medium.

The audio reproduction unit may comprise a position detection unit for detecting a position of the audio reproduction unit with respect to at least one further audio reproduction unit. Therefore, the position detection unit may also be provided within the audio reproduction unit, in contrast to an embodiment in which a position detection unit is implemented in the device.

The audio reproduction unit may comprise an acoustic wave generation unit for generating acoustic waves based on the audio content received by the audio content receipt unit and based on the local audio data received by the local audio data receipt unit. Such an acoustic wave generation unit may be the actual entity to generate the sound which can be perceived by a human user. This acoustic wave generation unit may be supplied with the audio data based on which the acoustic waves are output.

The system according to an embodiment of the invention may be adapted for using amplitude panning. The technology of amplitude panning has been described above in more detail.

However, although the system according to embodiments of the invention primarily intends to improve the playback of sound or audio data, it is also possible to apply the system for a combination of audio data and visual data. For instance, an embodiment of the invention may be implemented in audiovisual applications like a video player in which a loudspeaker is used, or a home cinema system.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 shows a device for generating audio data for transmission to a plurality of audio reproduction units according to an exemplary embodiment of the invention.

FIG. 2 shows a device for generating audio data for transmission to a plurality of audio reproduction units according to an exemplary embodiment of the invention.

FIG. 3 shows an audio reproduction unit according to an exemplary embodiment of the invention.

### DESCRIPTION OF EMBODIMENTS

The illustration in the drawing is schematically. In different drawings, similar or identical elements are provided with the same reference signs.

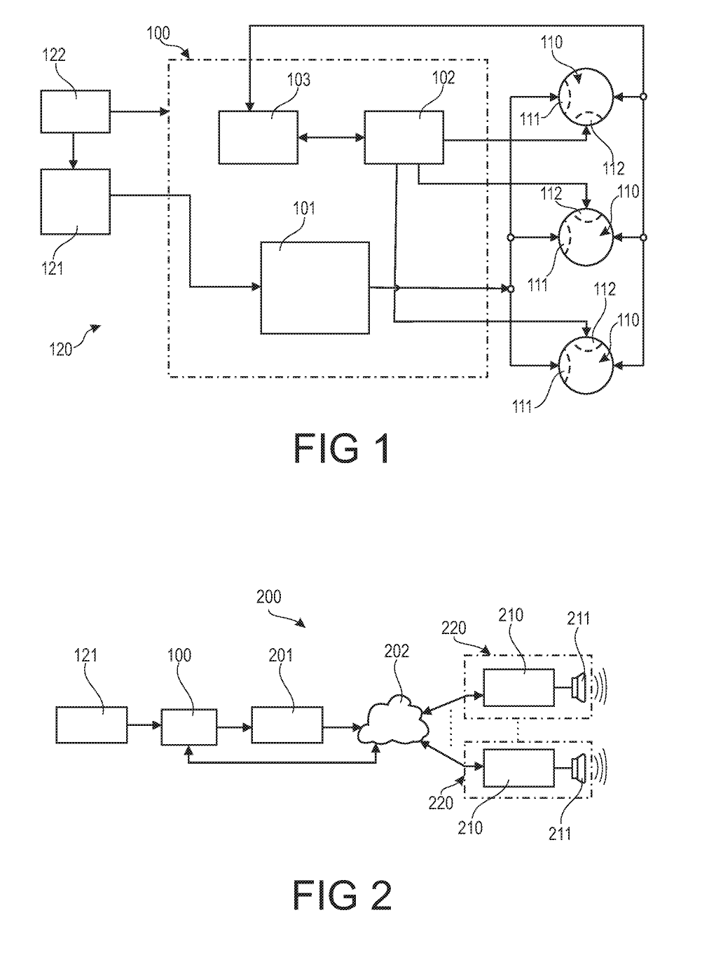

In the following, referring to FIG. 1, an audio surround system 120 will be explained.

The audio surround system 120 comprises a device 100 for generating audio data for transmission to a plurality of audio reproduction units 110, and comprises the plurality of audio reproduction units 110 connected to the device 100.

FIG. 1 shows an audio source 121 that is adapted for storing audio items to be reproduced. Such an audio source 121 may be a CD player, a DVD player, or a harddisk in a harddisk-based media player.

Under the control of a user input/output interface 122, audio items (for instance songs) stored in the audio source 121 may be provided to the device 100 for reproduction via the audio reproduction units 110 that are adapted as loudspeakers in this case 110.

Such a user interface 122 may be a graphical user interface (GUI). Such a graphical user interface 122 may include a display device (like a cathode ray tube, a liquid crystal display, a plasma display device or the like) for displaying information to a human operator respectively user, i.e. information such as data related to the audio playback. Furthermore, the user interface 122 may comprise an input unit allowing the user to input data (like data specifying the manner of playing back the audio content) or to provide the system with control commands. Such an input device may include a keypad, a joystick, a trackball, a touch screen or may even be a microphone of a voice recognition system. The interface 122 may allow a human user to communicate in a bi-directional manner with the system 120.

When a user wishes to reproduce a particular audio piece, the user provides corresponding commands via the user input/output unit 122. Consequently, a corresponding selected audio item stored on the audio source 121 is supplied from the audio source 121 to an audio content transmission unit 101 adapted to transmit the audio content for reproduction to the plurality of loudspeakers 110. Furthermore, the device 100 comprises a local audio data transmission unit 102 adapted to transmit local audio data individually to each of the plurality of audio reproduction units 110, the local audio data being indicative of a manner of processing transmitted audio content locally at the respective audio reproduction unit 110 to generate locally reproducible audio content.

Therefore, the audio content is provided in an unspecific manner from the audio content transmission unit 101 to each of the loudspeakers 110, in more detail to a respective audio content receipt unit 111 that is foreseen for each of the loudspeakers 110.

In contrast to this, the local audio data provided from the local audio data transmission unit 102 to each of the loudspeakers 110, in more detail to a corresponding local audio data input unit 112 of each of the loudspeakers 110, includes specific audio playback parameters which are assigned to the specific function of the individual loudspeaker 110. Therefore, the audio information received by the respective content receipt units 111 is identical for each respective content receipt unit 111, and the audio information received by the respective local audio data input units 112 of different loudspeakers 110 is different for each local audio data input unit 112. Particularly, respective gain and delay parameters are provided from the local audio data transmission unit 102 to the respective local audio data input units 112 of the loudspeakers 110. The communication between the device 100 and the loudspeakers 110 may be provided via a power line communication network.

A position detection unit 103 is provided in the device 100 and is coupled to the local audio data transmission unit 102 in such a manner that the local audio data is adjustable based on the detected position of each of the loudspeakers 110. As shown in FIG. 1, the position detection unit 103 is coupled to the loudspeakers 110 in a bidirectional manner. Therefore, the position detection unit 103 in combination with the loudspeakers 110 detects the actual positions of the individual loudspeakers 110. Based on this position(s), the local audio data transmission unit 102 may calculate suitable local audio data for the individual loudspeakers 110 in accordance with the actual position.

Each of the loudspeakers 110 processes internally the data received by the interface units 111, 112 and generates on this basis audible sound that may be perceived by a human listener.

In the following, referring to FIG. 2, a device 200 for generating audio data for transmission to a plurality of audio reproduction units 220 (loudspeaker units) according to an exemplary embodiment of the invention will be described.

As can be seen in FIG. 2, the audio source 121 is coupled to the device 100 (that may also be denoted as a server). The audio source 121 provides the server 100 with audio content. The server 100 is coupled to an audio encoder 201. The audio encoder 201 provides an encoded audio signal via a network 202 to each of the audio reproduction units 220. In more detail, the encoded audio signal is provided to each respective loudspeaker processing unit 210 of the audio reproduction units 220, which loudspeaker processing unit 210 is adapted to perform audio data processing to provide an output audio signal to a respective acoustic wave emission unit 211 that is adapted for actual emission of acoustic waves as sound.

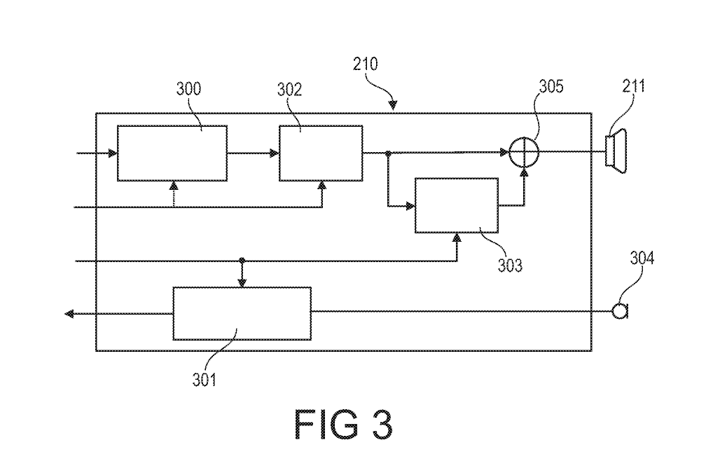

FIG. 3 shows a more detailed view of the structure of the audio reproduction units 220 of FIG. 2, in particular the loudspeaker processing unit 210 and the acoustic wave emission unit 211.

Particularly, the loudspeaker processing-unit 210 comprises an audio decoder unit 300, a gain unit 302, a noise shaper unit 303, a distance measurement unit 301, and a microphone 304 as a sound detector.

FIG. 2 therefore shows an overview of a dynamic scalable audio surround system 200 with audio reproduction units 220 at any desired position. FIG. 3 shows a loudspeaker unit of FIG. 2 with a processing module 210 and with an acoustic wave emitter 211 that is a loudspeaker in this case.

The system 200 comprises the audio source 121, like a CD or DVD player. The server 100 may be a computer or a microprocessor. The audio encoder unit 201 may be provided optionally for encoding multi channel audio. The network 202 can be, for example, a wireless network or a power line communication network. The audio reproduction units 220 may contain the actual loudspeaker 211 as an acoustic wave emitting device and the loudspeaker processing-module 210.

The server 100 may communicate with the audio reproduction units 220. It may compute gain information (or “gains” for short) and delay information (or “delays” for short) for each audio reproduction unit 220 and may send these information to the audio reproduction units 220. Moreover, the server 100 may initialize the audio reproduction units 220 when the distances between the audio reproduction units 220 have to be computed. Alternatively, the loudspeaker processing-unit 210 locally compute a position based on an ad-hoc network protocol.

The audio encoder 201 may optionally encode the audio, for example using SAC, before streaming the audio to the audio reproduction units 220. However, raw audio streams are also possible. Spatial audio coding (SAC) is a process to represent multichannel audio signals as down-mixed mono or stereo signals with spatial cues. The main strength of SAC is the significant bit-rate reduction while maintaining the perceptual sound quality.

In FIG. 3, the audio reproduction unit 220 is plotted in more detail. It comprises an optional audio decoder 300, which decodes the encoded audio received via the network 202. The audio channels are multiplied, in the gain adjustment unit 302, by gain parameters (the rendering), which are received from the server 100, and summed up by an adding unit 305 resulting in a one channel audio output. Optionally, the gains can also be used by the audio decoder 300, which is indicated by the dashed line in FIG. 3. This may result in an even more efficient rendering, and the post multiplications by the gains may be dispensable.

The loudspeaker 211 may play back the resulting one-channel audio signal. If the distances have to be computed, noise may be imperceptibly added to the resulting audio signal by using a psycho acoustic model. This audio reproduction unit 220 may also contain a microphone 304 to capture the noise from the other audio reproduction units 220 to compute the impulse responses and to determine the distances between different audio reproduction units 220 of the audio surround system. These distances may be sent to the server 100, which applies amplitude panning and computes a correct gain to be sent to the audio reproduction units 220.

It should be noted that the term “comprising” does not exclude other elements or features and the “a” or “an” does not exclude a plurality. Also elements described in association with different embodiments may be combined.

It should also be noted that reference signs in the claims shall not be construed as limiting the scope of the claims.

1. A device (100) for generating audio data for transmission to a plurality of audio reproduction units (110), the device (100) comprising
a first audio data transmission unit (101) adapted to transmit audio content for reproduction to the plurality of audio reproduction units (110);
a second audio data transmission unit (102) adapted to transmit local audio data individually to each of the plurality of audio reproduction units (110), the local audio data being indicative of a manner of processing the transmitted audio content locally at the respective audio reproduction unit (110) yielding locally reproducible audio content.

2. The device (100) according to claim 1,
wherein the first audio data transmission unit (101) is adapted to transmit shared audio content for reproduction to each of the plurality of audio reproduction units (110).

3. The device (100) according to claim 1,
wherein the first audio data transmission unit (101) is adapted to transmit audio content for reproduction to the plurality of audio reproduction units (110), said audio content being essentially independent of a number of the plurality of audio reproduction units (110) connected or connectable to the device (100).

4. The device (100) according to claim 1,
wherein the second audio data transmission unit (102) is adapted to transmit different local audio data to different of the plurality of audio reproduction units (110).

5. The device (100) according to claim 1,
wherein the second audio data transmission unit (102) is adapted to transmit local audio data individually to each of the plurality of audio reproduction units (110) so as to allow to render reproducible audio content locally at each of the plurality of audio reproduction units (110) using one or more spatial rendering parameters.

6. The device (100) according to claim 1,
wherein the second audio data transmission unit (102) is adapted to transmit local audio data individually to each of the plurality of audio reproduction units (110) so as to allow to render reproducible audio content locally at each of the plurality of audio reproduction units (110) using one or more gain parameter indicative of a gain of the reproducible audio content and/or one or more delay parameter indicative of a delay of reproducing the reproducible audio content.

7. The device (100) according to claim 1,
wherein the second audio data transmission unit (102) is adapted to transmit local audio data individually to each of the plurality of audio reproduction units (110), said local audio data being dependent on a number of the plurality of audio reproduction units (110).

8. The device (100) according to claim 1,
wherein the second audio data transmission unit (102) is adapted to transmit local audio data individually to each of the plurality of audio reproduction units (110), said local audio data being dependent on a spatial arrangement of the plurality of audio reproduction units (110).

9. The device (100) according to claim 1,
comprising a communication interface for a communication with the plurality of audio reproduction units (110).

10. The device (100) according to claim 9,
wherein the communication interface is adapted for a communication with the plurality of audio reproduction units (110) in a wired manner or in a wireless manner.

11. The device (100) according to claim 9, wherein the communication interface is adapted for a communication with the plurality of audio reproduction units (110) so as to form a power line communication network or a Bluetooth network.

12. The device (100) according to claim 9,
wherein the communication interface is adapted for a communication with an arbitrary number of reproduction units (110).

13. The device (100) according to claim 9,
wherein the communication interface is adapted for a communication with the plurality of reproduction units (110) in a dynamic manner.

14. The device (100) according to claim 1,
comprising a position detection unit (103) for detecting a position of at least a part of the plurality of audio reproduction units (110).

15. The device (100) according to claim 14,
wherein the position detection unit (103) is coupled to the second audio data transmission unit (102) in such a manner that the local audio data is adjustable based on the detected position of at least a part of the plurality of audio reproduction units (110).

16. The device (200) according to claim 1,
comprising an audio encoder unit (201) for encoding the audio content and/or the local audio data to be transmitted to the plurality of audio reproduction units (110).

17. The device (200) according to claim 16, wherein the audio encoder unit (201) is adapted for encoding using spatial audio coding.

18. The device (200) according to claim 1, comprising the plurality of audio reproduction units (110) connected or connectable to the first audio data transmission unit (101) and/or to the second audio data transmission unit (102).

19. The device (100) according to claim 1,
realized as at least one of the group consisting of an audio surround system, a gaming device, a DVD player, a CD player, a harddisk-based media player, an internet radio device, a public entertainment device, an MP3 player, a hi-fi system, a vehicle entertainment device, a car entertainment device, a medical communication system, and a home cinema system.

20. An audio reproduction unit (110) for reproducing audio data generated by a device (100) according to claim 1 for generating audio data for transmission to a plurality of audio reproduction units (110), the audio reproduction unit (110) comprising
a first audio data receipt unit (111) adapted to receive the audio content for reproduction;
a second audio data receipt unit (112) adapted to receive the local audio data being indicative of a manner of processing the received audio content locally by the audio reproduction unit (110) to generate locally reproducible audio content.

21. The audio reproduction unit (210) according to claim 20,
comprising a position detection unit (301) for detecting a position of the audio reproduction unit (210) with respect to at least one further audio reproduction unit.

22. The audio reproduction unit (210) according to claim 20,
comprising an acoustic wave generation unit (211) for emitting acoustic waves based on audio content received by the audio content receipt unit and based on local audio data received by the local audio data receipt unit (112).

23. The audio reproduction unit (210) according to claim 22,
being adapted for using amplitude panning.

24. A method of generating audio data for transmission to a plurality of audio reproduction units (110), the method comprising
transmitting audio content for reproduction to the plurality of audio reproduction units (110);
transmitting local audio data individually to each of the plurality of audio reproduction units (110), the local audio data being indicative of a manner of processing the transmitted audio content locally at the respective audio reproduction unit (110) yielding locally reproducible audio content.

25. A program element, which, when being executed by a processor (100), is adapted to control or carry out a method of generating audio data for transmission to a plurality of audio reproduction units (110), the method comprising:
transmitting audio content for reproduction to the plurality of audio reproduction units (110);
transmitting local audio data individually to each of the plurality of audio reproduction units (110), the local audio data being indicative of a manner of processing the transmitted audio content locally at the respective audio reproduction unit (110) yielding locally reproducible audio content.

26. A computer-readable medium, in which a computer program is stored which, when being executed by a processor (100), is adapted to control or carry out a method of generating audio data for transmission to a plurality of audio reproduction units (110), the method comprising:
transmitting audio content for reproduction to the plurality of audio reproduction units (110);
transmitting local audio data individually to each of the plurality of audio reproduction units (110), the local audio data being indicative of a manner of processing the transmitted audio content locally at the respective audio reproduction unit (110) yielding locally reproducible audio content.
